(19) United States
(12) Patent Application Publication
(10) Pub. No.: US 2026/0366649 A1
(43) Pub. Date: Nov. 19, 2026

(54) CABLE TIE DEVICE WITH MOUNTING SURFACE

(71) Applicant: Shawn Shelton, Mount Gilead, OH (US)

(72) Inventor: Shawn Shelton, Mount Gilead, OH (US)

(21) Appl. No.: 19/642,923

(22) Filed: Apr. 9, 2026

Related U.S. Application Data
(60) Provisional application No. 63/804,770, filed on May 13, 2025.

(51) Int. Cl. F16L 3/233; B65D 63/10

(52) U.S. Cl. CPC F16L 3/2332; B65D 63/1063

(57) ABSTRACT

A cable tie device with mounting surface is provided. The device is comprised of a cable tie with an integrated mounting platform enabling mechanical anchoring of the device and object retention. The device comprises a body including a head, a tail, and a strap section interconnecting the two, wherein the head is configured to receive the tail via a molded tie channel allowing unidirectional advancement. The head comprises a locking mechanism configured to engage ratcheting teeth disposed along the strap section and tail. Centrally or variably positioned along the strap is a mounting platform. The mounting platform may include one or more openings adapted to receive fasteners such as screws, rivets, or push-in clips. Additionally, in one embodiment the mounting platform may include an adhesive layer covered by a peelable covering with a removal tab, supporting attachment to smooth or coated surfaces.

### CROSS-REFERENCE TO RELATED APPLICATION

The present application claims priority to, and the benefit of, U.S. Provisional

Application No. 63/804,770, which was filed on May 13, 2025, and is incorporated herein by reference in its entirety.

### FIELD OF THE INVENTION

The present invention relates generally to the field of cable ties. More specifically, the present invention relates to a cable tie featuring an integrated mounting platform for securing the device to nearby surfaces using fasteners or adhesive. Accordingly, the present disclosure makes specific reference thereto. Nonetheless, it is to be appreciated that aspects of the present invention are also equally applicable to other like applications, devices, and methods of manufacture.

### BACKGROUND

In various construction, renovation, and repair environments, users are frequently required to organize and secure cables, conduits, or piping. The conventional approach often involves the use of traditional cable ties in combination with specialized hangers or brackets, each designed for different substrates or load conditions. This method imposes logistical challenges, as workers must select, transport, and store multiple types of mounting hardware, often leading to inefficiencies and increased material handling. Furthermore, standard cable ties lack integrated mounting features, which complicates their use on surfaces where fixed positioning is required. Makeshift attempts to anchor such cable ties using adhesives or improvised fasteners can result in insecure or misaligned installations, increasing the risk of mechanical failure or safety hazards. The manual process of securing cable ties without a predefined anchoring point adds to labor time and installation inconsistency. These limitations are especially pronounced in tight spaces or overhead applications, where stability during installation is critical. The absence of a reliable, integrated mounting solution within a single device has contributed to delays and reduced productivity for contractors, technicians, and DIY practitioners across numerous trades.

Therefore, there exists a long-felt need in the art for a cable tie device with mounting surface that provides an integrated a mounting platform to enable direct attachment of the device to surfaces. There also exists a long-felt need in the art for a cable tie device with mounting surface that reduces the dependency on specialized hangers and external brackets. Moreover, there exists a long-felt need in the art for a cable tie device with mounting surface that streamlines installation and enhances stability during cable or pipe management operations.

The subject matter disclosed and claimed herein, in one embodiment thereof, comprises a cable tie device with mounting surface. The device is comprised of a cable tie with an integrated mounting platform enabling mechanical anchoring of the device and object retention. The device comprises a body including a head, a tail, and a strap section interconnecting the two, wherein the head is configured to receive the tail via a molded tie channel allowing unidirectional advancement. The head comprises a locking mechanism configured to engage ratcheting teeth disposed along the strap section and tail. Centrally or variably positioned along the strap is a mounting platform. The mounting platform may include one or more openings adapted to receive fasteners such as screws, rivets, or push-in clips. Additionally, in one embodiment the mounting platform may include an adhesive layer covered by a peelable covering with a removal tab, supporting attachment to smooth or coated surfaces.

In this manner, the cable tie device with mounting surface of the present invention accomplishes all the foregoing objectives and provides a cable tie with an integrated mounting platform into the body of the device, thereby enabling direct surface attachment of the device without reliance on separate hardware. By allowing pre-anchoring to structural elements and supporting a range of fasteners or adhesive configurations, the device mitigates the need for specialty hangers and reduces installation time. The device further accommodates diverse cable and pipe geometries, enhancing load capacity without increasing bulk. This integration of mounting and fastening functions into a single device significantly improves efficiency, safety, and versatility for both professional and non-professional users in a range of installation scenarios.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cable tie device with mounting surface. The device is a cable tie comprising an integrated mounting platform designed to simplify installation by enabling surface anchoring before securing an object, thus reducing the need for separate brackets or hangers, thereby minimizing material use and labor.

The device is comprised of a body including a head, a tail, and a strap section connecting the head and tail. The head is dimensioned with a molded tie channel that allows unidirectional passage of the tail. The tie channel may vary in shape and include features to reduce insertion resistance and enhance tail movement during installation. The head includes a locking mechanism that engages with ratcheting teeth located on the outer surface of the strap section and/or tail.

The strap section incorporates at least one mounting platform, which may be centrally or asymmetrically positioned depending on anchoring orientation. The mounting platform may include planar, curved, or contoured exterior surfaces designed to conform to diverse substrate shapes. The mounting platform may include a solid or perforated body with one or more openings for receiving fasteners such as screws, nails, bolts, rivets, clips, or inserts. The geometry of the mounting platform may vary and include circular, U-shaped, or semi-cylindrical profiles to accommodate structural features or curved surfaces. In some embodiments, the mounting platform includes an adhesive layer covered by a peelable covering. The peelable covering may feature a tab for easy removal during use.

Accordingly, the cable tie device with mounting surface of the present invention is particularly advantageous as it provides a cable tie with an integrated mounting platform into the body of the device, thereby enabling direct surface attachment of the device without reliance on separate hardware. By allowing pre-anchoring to structural elements and supporting a range of fasteners or adhesive configurations, the device mitigates the need for specialty hangers and reduces installation time. The device further accommodates diverse cable and pipe geometries, enhancing load capacity without increasing bulk. This integration of mounting and fastening functions into a single device significantly improves efficiency, safety, and versatility for both professional and non-professional users in a range of installation scenarios and overcomes the limitations of existing cable ties and methods of use known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a rear view of one potential embodiment of a cable tie device with mounting surface of the present invention in accordance with the disclosed architecture;

FIG. 2 illustrates an enhanced perspective view of one potential embodiment of a cable tie device with mounting surface of the present invention in accordance with the disclosed architecture;

FIG. 3 illustrates a perspective view of one potential embodiment of a cable tie device with mounting surface of the present invention while attached to a surface in accordance with the disclosed architecture;

FIG. 4 illustrates a flowchart of a method of using one potential embodiment of a cable tie device with mounting surface of the present invention in accordance with the disclosed architecture; and

FIG. 5 illustrates a perspective view of one potential embodiment of a cable tie device with mounting surface of the present invention while attached to a surface in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a cable tie device with mounting surface that provides an integrated a mounting platform to enable direct attachment of the device to surfaces. There also exists a long-felt need in the art for a cable tie device with mounting surface that reduces the dependency on specialized hangers and external brackets. Moreover, there exists a long-felt need in the art for a cable tie device with mounting surface that streamlines installation and enhances stability during cable or pipe management operations.

The present invention, in one exemplary embodiment, is comprised of a cable tie device with mounting surface. The device is comprised of a table tie that integrates a mounting platform into the structure of the cable tie, thus enabling anchoring to a surface prior to securing an object with the cable tie. This configuration eliminates the need for separate brackets or hangers, thereby reducing material consumption and labor requirements while simplifying installation.

The body of the device is comprised of a head, a tail, and an interconnecting strap section. The head features a molded tie channel dimensioned to allow unidirectional advancement of the tail. The channel may vary in shape and may include structural features that minimize insertion resistance and facilitate smooth tail movement during installation. A locking mechanism is incorporated into the head to engage with ratcheting teeth positioned on the outer surface of the strap section and/or tail.

The strap section includes at least one mounting platform, which may be centrally or asymmetrically positioned to suit various anchoring orientations. The mounting platform may be comprised of planar, contoured, or curved exterior surfaces to conform to different substrate geometries. A solid or perforated platform body may include one or more openings configured to receive fasteners such as screws, nails, bolts, rivets, clips, or inserts. The platform geometry may vary, including circular, U-shaped, or semi-cylindrical forms to accommodate different structural features or curved surfaces. In certain embodiments, the mounting platform also includes an adhesive layer protected by a peelable covering, which may include a tab for facilitated removal during installation.

As a result, the device provides a cable tie that enables direct attachment to structural surfaces without requiring additional hardware. By supporting both mechanical fasteners and adhesive attachment methods, the device allows pre-anchoring and accommodates a range of installation needs. The device is further capable of securing various cable and pipe geometries and improving load capacity without added bulk. This combination of anchoring and fastening functions within a single device enhances installation efficiency, user safety, and functional versatility, addressing limitations found in conventional cable ties known in the art.

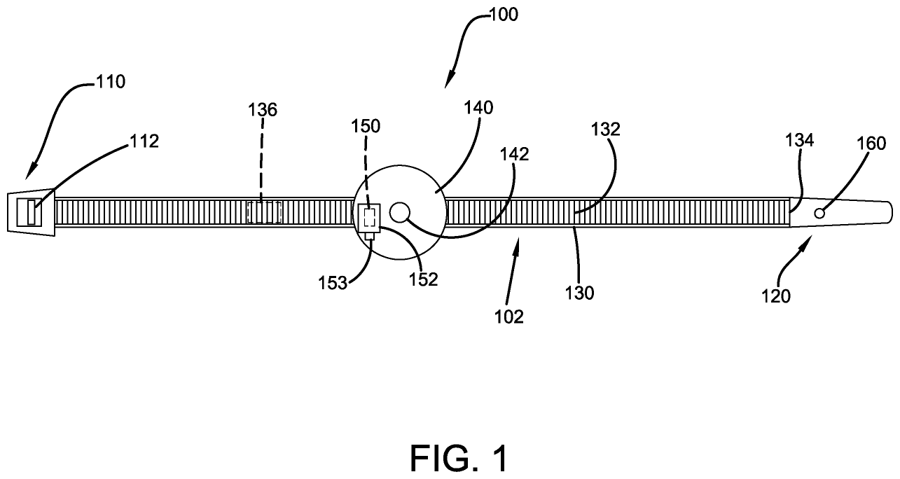

Referring initially to the drawings, FIG. 1 illustrates a rear view of one potential embodiment of a cable tie device with mounting surface 100 of the present invention in accordance with the disclosed architecture. The device 100 is a cable tie that simplifies usage and the installation process by integrating a strategically positioned mounting platform 140 directly into the device 100. This integrated configuration enables the device 100 to be anchored to a surface using the mounting platform 140 and an additional fastener prior to encircling and securing an object with the remainder of the device 100. By combining mechanical anchoring and object retention within a single device 100, the need for multiple specialized brackets, clamps, or hangers may be eliminated, and overall material usage and labor requirements may be reduced.

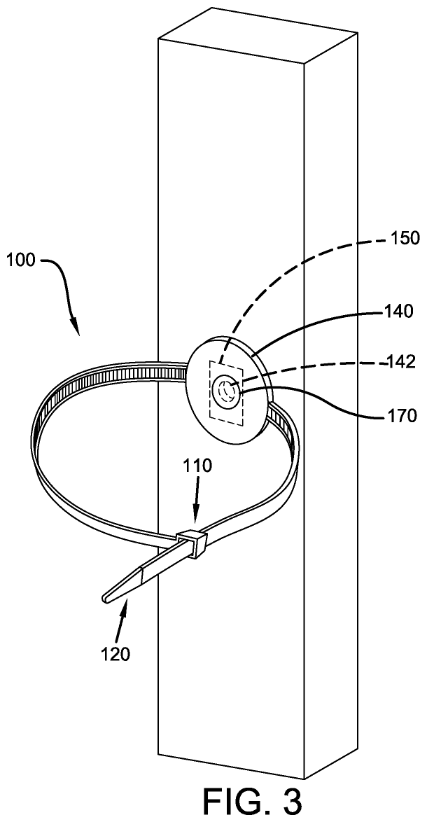

The device 100 may be comprised of a body 102 having a head 110, a tail 120, and a strap section 130 interconnecting the head 110 and the tail 120. The head 110 may be dimensioned to receive the tail 120 via a molded tie channel 112 that permits unidirectional advancement of the tail 120 through the head 110, as seen in FIG. 3. The tie channel 112 may be linear, curved, or tapered in shape depending on the intended routing or strain relief application. The tie channel 112 may further be chamfered, radiused, or contoured to reduce insertion resistance and promote smooth movement of the tail 120 during installation through the head 110.

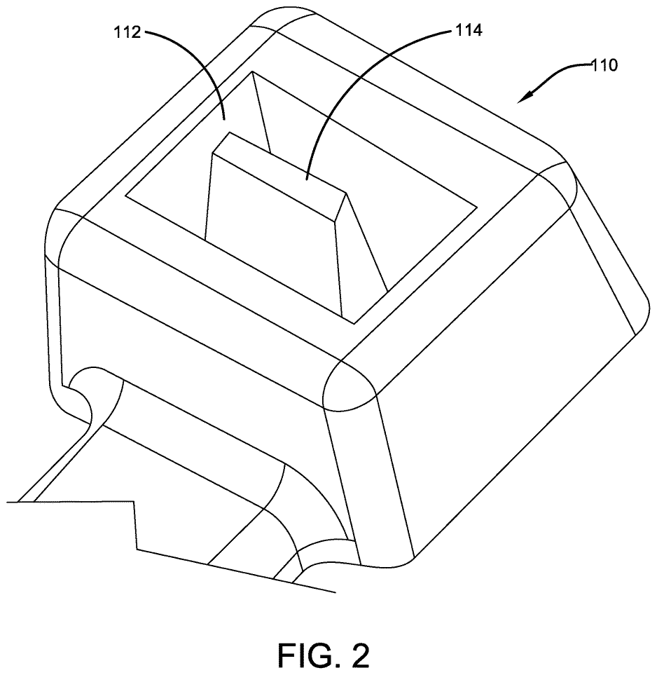

The head 110 may be further comprised of a locking mechanism 114, as seen in FIG. 2, such as but not limited to any combination of a cantilevered pawl, ratcheting tab, spring-biased projection, or integrally molded flexible arm configured to engage with a plurality of ratcheting teeth 132 disposed along the outer surface 134 of the strap section 130 and/or tail 120.

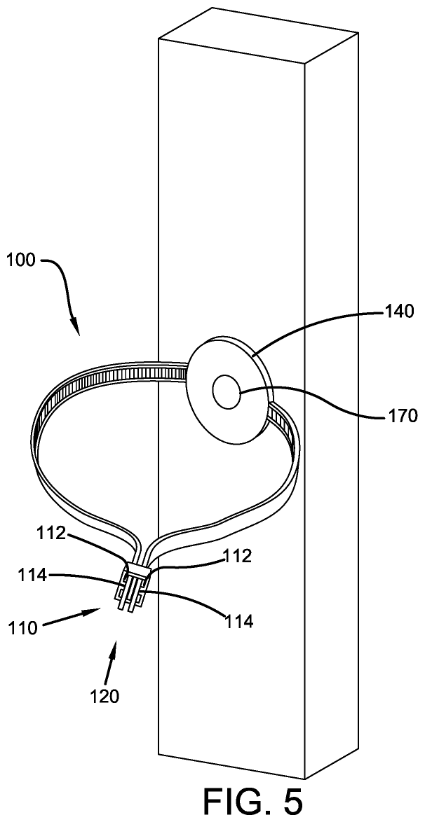

In one embodiment, the device 100 has two channels 112 as seen in FIG. 5, wherein each channel 112 has a locking mechanism 114. This embodiment allows the tail 120 to be pulled through the first of the channels 112 and the head 110 side of the body 102 to be pulled through the second channel 112. As a result, both sides of the body 102 are adjustable through the channels 112.

The ratcheting teeth 132 may be uniformly spaced or variably pitched based on load-bearing or positional precision requirements. The teeth 132 may be comprised of but are not limited to triangular, trapezoidal, sawtooth, or wave-like teeth, with each geometry selected to optimize engagement with the locking mechanism 114.

The strap section 130 may be flexible and comprised of a cross-sectional profile that is uniform, stepped, tapered, or segmented. The width and thickness of the strap 130 may vary along the length of the strap section 130 to facilitate bending around objects with complex geometries. In one embodiment, the strap 130 may be comprised of at least one reinforcement feature 136 such as but not limited to any combination of internal ribs, embedded mesh, lattice patterns, or longitudinal fibers to increase load-bearing capacity without increasing bulk.

The strap section 130 is further comprised of at least one mounting platform 140, as seen in FIG. 1, which may be centrally positioned, longitudinally offset, or laterally displaced relative to the strap 130 axis depending on the anchoring orientation. The mounting platform 140 may be comprised of at least one planar, curved, or contoured exterior surface 131 designed to conform to various substrate shapes including flat panels, cylindrical housings, or structural members.

In one embodiment, the mounting platform 140 may be comprised of a solid or perforated body with one or more openings 142 designed to receive fasteners 170 such as but not limited to screws, nails, bolts, rivets, push-in clips, or self-tapping inserts. The size, shape, and quantity of the openings 142 may be adapted based on the selected fastener type and required load distribution.

The geometry of the mounting platform 140 may vary across embodiments. In one embodiment, the platform 140 is circular in shape. In another embodiment, the platform 140 may be U-shaped, allowing the platform 140 to straddle or partially wrap around structural features such as framing studs, tubular supports, or conduit bodies. In another embodiment, the platform 140 may be comprised of a semi-cylindrical profile, permitting a more stable attachment to curved surfaces such as poles or rounded enclosures.

In one embodiment, the mounting platform 140 may additionally or alternatively be comprised of an adhesive layer 150 covered by a peelable covering 152, as seen in FIG. 1. The adhesive 150 may be but is not limited to any combination of pressure-sensitive adhesives, heat-activated adhesives, UV-curable adhesives, or hybrid bonding agents depending on application constraints. The adhesive 150 may be formulated to bond with substrates such as but not limited to painted metal, smooth plastics, glass, wood, composite laminates, coated surfaces, etc. The peelable covering 152 may be comprised of a tab 153 to facilitate removal during installation.

The device 100 may be manufactured from a seamless or molded polymeric material, which may include but is not limited to any combination of a nylon, high-density polyethylene (HDPE), polypropylene, acetal, or other engineered thermoplastics. The material may be comprised of an additive 160 such as but not limited to any combination of glass fibers, carbon fibers, UV stabilizers, flame retardants, etc.

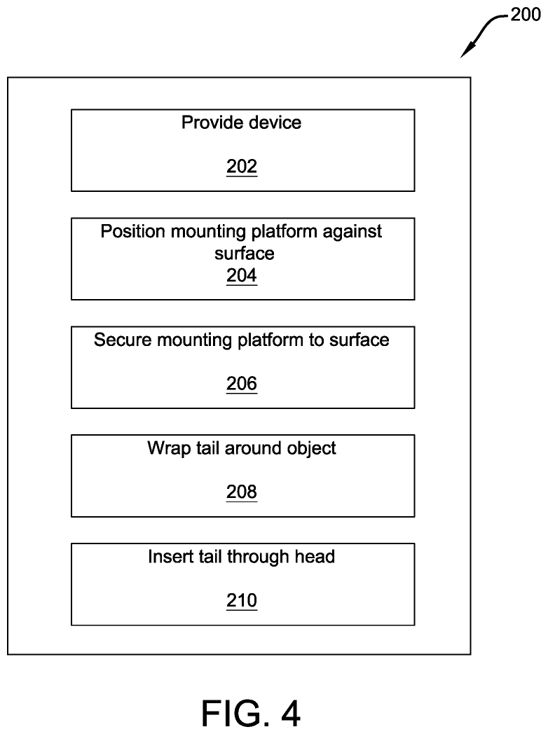

The present invention is also comprised of a method of using 200 the device 100, as seen in FIG. 4. First, a device 100 is provided comprised of a body 102 having a head 110, a tail 120, and a strap section 130 interconnecting the head 110 and the tail 120, wherein the strap section 130 is further comprised of at least one mounting platform 140 [Step 202]. Then, the mounting platform 140 may be positioned against a surface selected for anchoring, wherein the mounting platform 140 may be comprised of at least one opening 142 and/or an adhesive layer 150 covered by a peelable covering 152 [Step 204]. Next, the mounting platform 140 may be secured to the surface using at least one fastener 170 inserted through the opening 142 and/or by removing the peelable covering 152 and pressing the adhesive layer 150 against the surface (if present), as both seen in FIG. 3 [Step 206]. After the device 100 is anchored, the tail 120 may be wrapped around at least one object intended to be retained by the strap section 130 (wherein the position of the device 100 in this step is shown in FIG. 3) [Step 208]. Then, the tail 120 may be inserted into the head 110 via the tie channel 112, as seen in FIG. 3, wherein the tail 120 advances unidirectionally through the head 110 [Step 210]. The locking mechanism 114 within the head 110 then engages the ratcheting teeth 132 disposed along the strap section 130 and/or tail 120 to retain the object securely. The strap section 130 may further conform around the object due to its flexible geometry, and the device 100 may remain fixed to the surface via the mounting platform 140.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cable tie device with mounting surface” and “device” are interchangeable and refer to the cable tie device with mounting surface 100 of the present invention.

Notwithstanding the foregoing, the cable tie device with mounting surface 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cable tie device with mounting surface 100 as shown in the FIGS. are for illustrative purposes only, and that many other sizes and shapes of the cable tie device with mounting surface 100 are well within the scope of the present disclosure. Although the dimensions of the cable tie device with mounting surface 100 are important design parameters for user convenience, the cable tie device with mounting surface 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cable tie device with mounting surface comprising:
a body comprised of a head, a tail, and a strap section interconnecting the head and the tail;
wherein the head is comprised of a tie channel dimensioned to receive the tail and configured to permit unidirectional advancement of the tail through the head; and
further wherein the strap section comprises a mounting platform having an adhesive layer.

2. The cable tie device with mounting surface of claim 1, wherein the adhesive layer is comprised of a peelable covering.

3. The cable tie device with mounting surface of claim 1, wherein the peelable covering is comprised of a tab.

4. The cable tie device with mounting surface of claim 1, wherein the mounting platform is comprised of a planar, a curved, or a contoured exterior surface.

5. The cable tie device with mounting surface of claim 1, wherein the mounting platform is comprised of a circular shape, a u-shape, or a semi-cylindrical shape.

6. The cable tie device with mounting surface of claim 1, wherein the strap section is comprised of a reinforcement feature.

7. The cable tie device with mounting surface of claim 6, wherein the reinforcement feature is comprised of an internal rib, an embedded mesh, a lattice pattern, or a longitudinal fiber.

8. The cable tie device with mounting surface of claim 1, wherein the head is comprised of a locking mechanism.

9. The cable tie device with mounting surface of claim 8, wherein the locking mechanism is comprised of a cantilevered pawl, a ratcheting tab, a spring-biased projection, or an integrally molded flexible arm.

10. The cable tie device with mounting surface of claim 1, wherein the tie channel is a chamfered tie channel, a radiused tie channel, or a contoured tie channel.

11. A cable tie device with mounting surface comprising:
a body comprised of a head, a tail, and a strap section interconnecting the head and the tail;
wherein the head is comprised of a tie channel dimensioned to receive the tail and configured to permit unidirectional advancement of the tail through the head; and
further wherein the strap section comprises a mounting platform having an opening configured to receive a fastener.

12. The cable tie device with mounting surface of claim 11, wherein the mounting platform is comprised of an adhesive layer.

13. The cable tie device with mounting surface of claim 11, wherein the adhesive layer is comprised of a peelable covering.

14. The cable tie device with mounting surface of claim 11, wherein the peelable covering is comprised of a tab.

15. The cable tie device with mounting surface of claim 11, wherein the head is comprised of a locking mechanism.

16. The cable tie device with mounting surface of claim 15, wherein the locking mechanism is comprised of a cantilevered pawl, a ratcheting tab, a spring-biased projection, or an integrally molded flexible arm.

17. The cable tie device with mounting surface of claim 11, wherein the mounting platform is comprised of a planar, a curved, or a contoured exterior surface.

18. The cable tie device with mounting surface of claim 11, wherein the mounting platform is comprised of a circular shape, a u-shape, or a semi-cylindrical shape.

19. The cable tie device with mounting surface of claim 11 further comprised of a glass fiber, a carbon fiber, a UV stabilizer, or a flame retardant.

20. A method of using a cable tie device with mounting surface, the method comprising the following steps:
providing a cable tie device with mounting surface comprised of a body comprised of a head, a tail, and a strap section interconnecting the head and the tail, wherein the strap section comprises a mounting platform;
positioning the mounting platform against a surface that is selected for anchoring;
securing the mounting platform to the surface;
wrapping the tail around an object intended to be retained by the strap section; and
inserting the tail into the head via the tie channel, wherein the tail advances unidirectionally through the head.
